(19) United States
(12) Patent Application Publication
(10) Pub. No.: US 2019/0146241 A1
(43) Pub. Date: May 16, 2019

(54) KIND OF ELASTIC HINGE THAT CAN MAKE THE EARPIECE EXTEND OUTWARDS AND PRODUCTION METHOD

(71) Applicant: HUANG HONGZHI, Yuhuan City (CN)

(72) Inventor: HUANG HONGZHI, Yuhuan City (CN)

(21) Appl. No.: 16/114,202

(22) Filed: Aug. 27, 2018

(30) Foreign Application Priority Data
Nov. 15, 2017 (CN) 201711129080.0

(51) Int. Cl. G02C 5/22

(52) U.S. Cl. CPC G02C 5/2245; G02C 2200/06; G02C 2200/26

(57) ABSTRACT

An elastic hinge that can make the earpiece extend outwards includes a slingshot case secured to an earpiece and slingshot core secured to a frame. The slingshot case has an installation hole, into which the slingshot core is inserted and fixed. The slingshot core has an installation base and central spindle which is fixed onto the installation base and extends inside the installation hole. A fixed tube and a spring are provided on the spindle, and a stopper is provided to stop the spring and fixed tube from coming apart. A pair of barbs, which are elastic and able to retract or dilate, are provided on the fixed tube, and which interact with a ring inside the installation hole. When the fixed tube passes through the ring, the barbs retract and then extend outwards to thereby connect the slingshot core and slingshot case.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to eyeglass frame and eyeglass accessories technology and particularly relates to the hinge connecting the earpiece and the frame, specifically a kind of elastic hinge that can make the earpiece extend outwards. The present invention also relates to its production methods.

### BACKGROUND OF THE INVENTION

It is a problem in the art to provide a resilient frame hinge for an eyeglasses frame having an elastic hinge. The elastic hinge includes a slingshot case and slingshot core. The slingshot case is welded to the earpiece and the slingshot core is mounted on the edge of the frame. Once the slingshot core is inserted into the slingshot case, the earpiece and frame are joined together. Because the slingshot core is equipped with spring, it provides the frame certain elasticity when the earpiece opens or closes. At the same time, when the earpiece opens, it opens a small angle when it extends outwards to adapt to the head of a wearer, and ensure more comfortable and secure wear.

In order to prevent the slingshot core from falling out after insertion into the slingshot case, the patent document with the document number of CN202306034U shows the structure of a kind of slingshot core connected inside the slingshot case. In the structure, a mounting groove is provided inside the slingshot case and the central spindle of the slingshot core is provided with mounting pieces, which include the mounting sleeve and a clip secured at the end of the mounting sleeve. The clip works on the side wall of the mounting groove to prevent the slingshot core from being drawn out. One of the defects of this structure is that one end of the mounting sleeve touches the spring whereas the other end doesn't have a contacting surface or structure for position limiting. Therefore when the slingshot core is inserted into the slingshot case, the dilated clip above the mounting sleeve becomes pressed, it starts to retract and produces an axial pushing force on the mounting sleeve, which may cause the mounting sleeve to slide opposite the spring and cause the clip to get stuck in between the slingshot core and slingshot case and hence result in assembly failure. In addition, because the contact surface between the mounting sleeve and the central spindle on the slingshot core is small, it results in poor stability. Because of the poor stability after the earpiece is connected to the frame, the earpiece is likely to shake or swerve and therefore negatively affect the general quality and performance of the glasses.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an improved eyeglass hinge that is elastically deformable.

The purpose of this invention is to provide a smooth and structurally stable elastic hinge that can make the earpiece extend outwards and its production method. The purpose of this invention is achieved as follows: a kind of elastic hinge that can make the earpiece extend outwards, including slingshot case and slingshot core. The slingshot case is welded onto the earpiece; the slingshot core is fixed on the frame; one end of the slingshot case has been provided with an installation hole, into which the slingshot core is inserted and fixed inside the case. the slingshot core is comprised of installation base and central spindle; the installation base shall match the hole pattern on top of the installation hole; the central spindle is fixed onto the installation base and extends into inside of the installation hole; on the central spindle, there are a fixed tube and a spring; at the end of the central spindle, there is the stopper to stop the spring and fixed tube from falling; the wall of the fixed tube has at least two barbs, which are elastic and able to retract or dilate; inside the installation hole a ring has been provided; when the fixed tube passes through the ring, the barbs retracts first and extends outwards and then works on the ring so that the slingshot core and slingshot case are connected.

Pursuant to the function and role of the ring, it may have two structures shown as follows: 1) the clip is a ring-shaped groove whose inner diameter is greater than the inner diameter of the installation hole; when the slingshot core is being inserted into the slingshot case, the inner wall of the installation hole presses the barbs to make them retract; when it passes the ring-shaped groove, the barbs dilate outwards and work on the bottom or walls of the ring-shaped groove to secure the slingshot core to the slingshot case. 2) the clip is a ring-shaped convex ring whose inner diameter is smaller than the inner diameter of the installation hole but greater than the diameter of the central spindle equipped with fixed tube and spring; the central spindle is provided with fixed tube and spring; when it passes through the ring-shaped convex ring, the convex ring presses the barbs to make them retract; when it passes successfully, the barbs dilate outwards and work on the surface or walls of the convex ring.

In addition to the above technical proposals, the following features are also provided: the barbs are cut from the walls of the fixed tube where return holes matching the barbs are formed; when the barbs retract, they can adapt into the return holes which are formed by stretching and dilating after the barbs are cut.

As a further improvement, the hole of the fixed tube is square, the central spindle has been provided with a corresponding flanged shaft which has a square end face to match with the tube hole; the fixed tube sleeve is mounted on the flanged shaft, so that it is fixed on the central spindle and unable to be moved, which again improves stability.

An additional improvement is that the wall of the fixed tube has two barbs located on the opposite walls of the fixed tube. Other improvements are as follows: the hole of the fixed tube is round; the tube wall has four evenly arranged barbs to facilitate the assembly of the fixed tube and no adjustment is necessary. A further improvement is that the wall of the fixed tube has fixed wing extending along the axis from one end; the installation base has corresponding fixed groove; the fixed wing can fit into the fixed groove to prevent the fixed tube from swerving, which increases stability.

In a further improvement, the installation base and the hole at the top of the installation hole are both square shape to prevent slingshot core and slingshot case from moving around rotatably relative to each other.

The production of a kind of elastic hinge that can make the earpiece extend outwards, which is shown as below:
Step 1. Select right sized section bar; stretch and form the section bar with the drawing die to produce slingshot case;
Step 2. Cut the sheet material with laser and produce slingshot core according to the dimensional requirements;
Step 3. Cut the sheet material with laser to produce barb; after cutting according to the prescribed description, it will be rolled into fixed tube and extend to dilate the barbs;
Step 4. Connect the fixed tube into the central spindle of the slingshot core before it is connected to the spring; at last, press the end of the central spindle to form the stopper;
Step 5. Insert the slingshot core into the slingshot case to complete the assembly.

Compared to existing technology, this invention has improvements that produce improved technological outcomes, these improvements including: large contact area between the fixed tube and the central spindle; both ends limiting device in place which makes it difficult for them to make axial movement; when the barbs are pressed or work on the slingshot case, there is a solid foundation in place; during assembly, barbs can retract into the return hole, which reduces the resistance for the slingshot core to go inside the slingshot case and guarantees easy assembly, saving time and labor; in addition, the fixed tube and slingshot core are securely connected without any swerving; the slingshot core and slingshot case are reliably connected without swerving, too, which improves the opening/closing stability of the earpiece without swerving, improves the quality of the glasses and comfort of wear, and increases its service life.

Other objects and advantages of the present invention will be more readily apparent from the following detailed description when read in conjunction with the accompanying drawings.

### BRIEF DESCRIPTION OF THE DRAWINGS

FIG. 1 is a top elevational view, partially in cross-section, of a first embodiment of an elastic hinge with a slingshot case and a slingshot core, according to the present invention;

FIG. 2 is a side cross-sectional view of the slingshot case according to FIG. 1;

FIG. 3 is a cross-sectional view of a second embodiment of an elastic hinge with a slingshot core, similar to that of FIG. 1;

FIG. 4 is a cross-sectional view of the slingshot case of FIG. 3;

FIG. 5 is a perspective view of the slingshot case of FIG. 1;

FIG. 6 is a perspective view of the slingshot core with additional components according to the present invention;

FIG. 7 is a perspective view of the slingshot core of FIG. 6;

FIG. 8 is a side elevational view of a fixed tube used in the device of FIG. 3;

FIG. 9 is a right elevational view of the fixed tube of FIG. 8;

FIG. 10 is a further perspective view of the slingshot core and the components of FIG. 6;

FIG. 11 is a perspective view of the slingshot core of FIG. 10;

FIG. 12 is a perspective view of the fixed tube of FIG. 10; and

FIG. 13 is a perspective view of an alternative embodiment of the fixed tube according to the invention.

### DETAILED DESCRIPTION OF THE INVENTION

### Embodiment 1

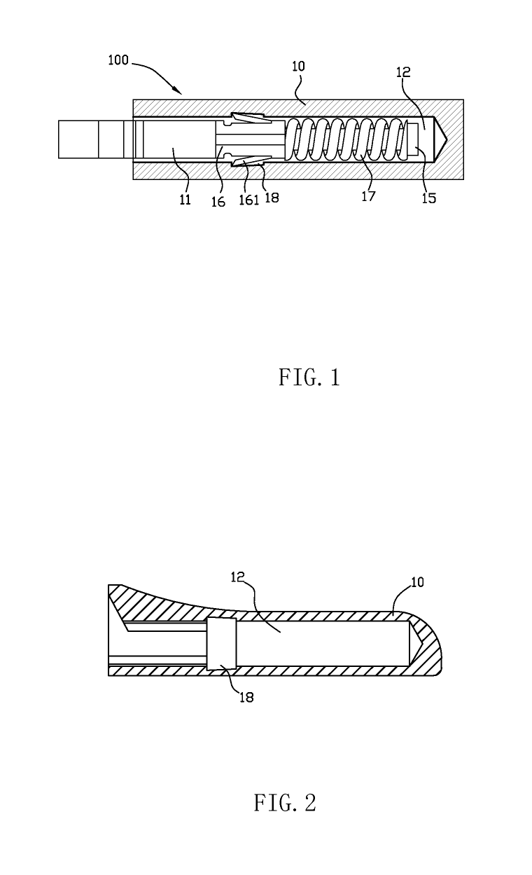

FIG. 1 is a top elevational view, partially in cross-section, of a first embodiment of an elastic hinge 100 with a slingshot case 10 and a slingshot core 11, according to the present invention. FIG. 1 also shows an installation hole 12, a stopper 15, a fixed tube 16 and a spring 17. A ring-shaped groove 18 is disposed in the slingshot case 10. The fixed tube 16 has barbs 161. One end of the spring 17 pushes against the stopper 15, and the other end of the spring 17 pushes against the fixed tube 16.

FIG. 2 is a side cross-sectional view of the slingshot case 10 of FIG. 1.

As shown in FIG. 1 and FIG. 2, this is a kind of elastic hinge 100 that is connected to the earpiece (not shown) extend outwards. It includes the slingshot case 10 and the slingshot core 11. The slingshot case 10 is welded to the earpiece, and the slingshot core 11 is mounted on the eyeglass frame (not shown).

One end of the slingshot case 10 has been provided with an installation hole 12, into which the slingshot core 11 is inserted and fixed inside the case 10 in the manner shown in the drawings and described below. The installation hole 12 can also be referred to as a passageway or bore formed in the slingshot case 10.

As shown in detail in FIG. 6, the slingshot core 11 is composed of an installation base 13 and a central spindle 14; the installation base 13 shall match the hole pattern on top of the installation hole 12; the installation base 13 and the hole at the top of the installation hole 12 are both square shape to prevent slingshot core 11 and slingshot case 10 from moving around; the central spindle 14 is mounted on the installation base 13 and extends inside of the installation hole 12. The central spindle 14 is provided with the fixed tube 16 and the spring 17. The end of the central spindle 14 has the stopper 15 to prevent the spring 17 and fixed tube 16 from falling off.

The wall of the fixed tube 16 has been provided with two barbs 161, which are elastic and capable of retracting and expanding. The barbs 161 have an initial configuration when no external force is applied, and a deformed configuration when under an external force. Application of an external force occurs, for example, during insertion of the fixed tube 16 into the installation hole 12 which causes the barbs 161 to retract. Release of the external force allows the barbs 161 to expand back to their initial configuration.

There is a ring-shaped groove 18 inside the installation hole 12, as seen in FIG. 1. The ring-shaped groove 18 is bounded by a substantially cylindrical groove wall (unnumbered) and opposed side walls (unnumbered), as seen in FIG. 1, which together define the ring-shaped groove 18.

The ring-shaped groove 18 serves as a clip whose inner diameter is larger than the diameter of the installation hole 12 so that when the slingshot core 11 is inserted into the slingshot case 10, the inner wall of the installation hole 12 presses on the barb 161 and makes it retract; and when the slingshot core 11 passes through the ring-shaped groove 18, the barbs 161 expand outwards and abuts the groove wall and either of the opposed side walls of the ring-shaped groove 18 and thereby lock the slingshot core 11 and the slingshot case 10 together.

### Embodiment 2

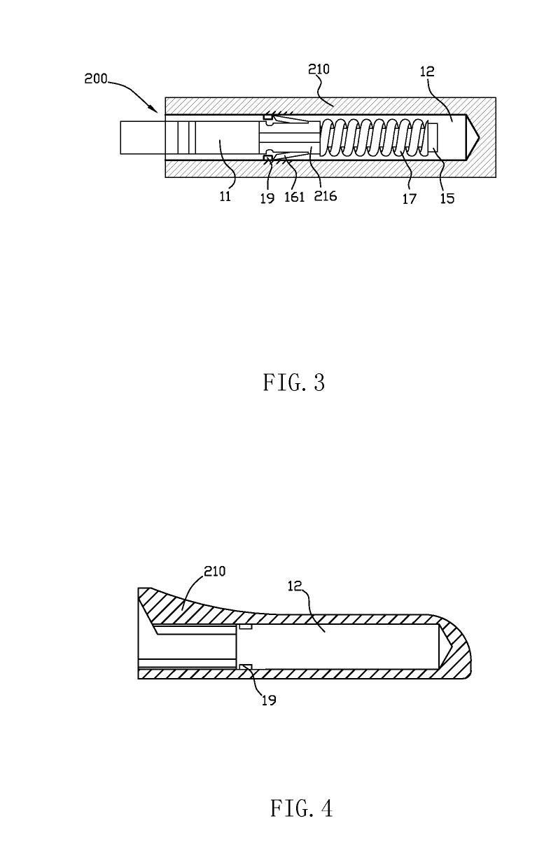

FIG. 3 is a cross-sectional view of a second embodiment of an elastic hinge 200 with a slingshot core 11, similar to that of FIG. 1.

FIG. 4 is a cross-sectional view of the slingshot case 210 of FIG. 3.

As shown in FIG. 3 and FIG. 4, this is a kind of elastic hinge 200 that can make the earpiece (not shown) extend outwards. It includes a slingshot case 210 and a slingshot core 11 which is similar to the like-numbered element of FIGS. 1 and 2.

The slingshot case 210 is welded to the earpiece (not shown) and the slingshot core 11 is mounted on the frame (not shown). One end of the slingshot case 210 has been provided with an installation hole 12, into which the slingshot core 11 is inserted and fixed inside the case 210. The slingshot core 11 is composed of an installation base 13 and a central spindle 14 (which are similar to those shown and described in FIGS. 1 and 2). The installation base 13 shall match a hole pattern (i.e. the cross sectional shape of the installation hole) at an entryway to the installation hole 12, the entryway being disposed at a leftmost end of the slingshot case 210 as viewed in FIG. 3.

The installation base 13 and the above-mentioned entryway at the leftmost end of the installation hole 12 are both of square cross-sectional shape to prevent the slingshot core 11 and the slingshot case 210 from rotating relative to each other. The central spindle 14 is mounted on the installation base 13 and extends inside the installation hole 12. The central spindle 14 has been provided with a fixed tube 16 and a spring 17 (which are similar to those shown and described in FIGS. 1 and 2) in proper order. The end of the central spindle 14 has a stopper 15 to prevent the spring 17 and fixed tube 16 from falling off the spindle 14.

The wall of the fixed tube 16 has been provided with two barbs 161 (which are similar to those shown and described in FIGS. 1 and 2), which are elastic and capable of retracting and expanding. Inside the installation hole 12 there is a clip 19, which is a ring-shaped convex ring 19 whose inner diameter is smaller than the diameter of the installation hole 12 but larger than the diameter of the central spindle 14 that has been provided with the fixed tube 16 and the spring 17 so that the spindle can move in a direction along the length of the installation hole 12. The central spindle 14 has been provided with a fixed tube 16 and a spring 17; when the central spindle 14 passes the ring-shaped convex ring 19, the ring-shaped convex ring 19 presses on the barbs 161 such that the barbs 161 retracts. After the barbs 161 have passed through the ring 19, the barbs 161 expand outwards and prevent retraction of the fixed tube 16 from the installation hole 12, by abutting the end faces (unnumbered) of the ring-shaped convex ring 19.

### Slingshot Core Components

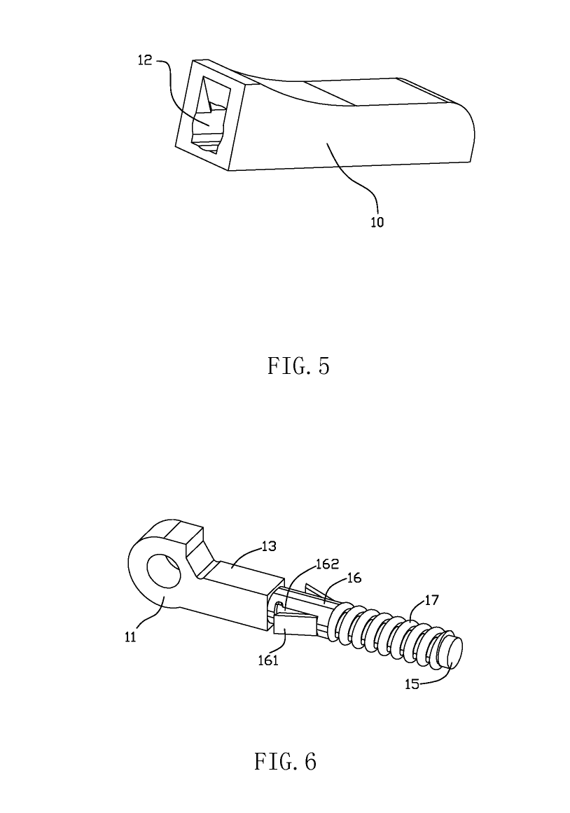

FIG. 5 is a perspective view of the slingshot case 10 of FIG. 1. The case 10 has an opening entryway that is generally rectangular in cross section.

FIG. 6 is a perspective view of the slingshot core 11 with additional components which include the fixed tube 16 and the spring 17. The slingshot core 11 has an enlarged head portion (unnumbered) at one end which opposite from the stopper. The enlarged head portion is adapted to be gripped for assembly and removal, and has a substantially circular opening therein (unnumbered).

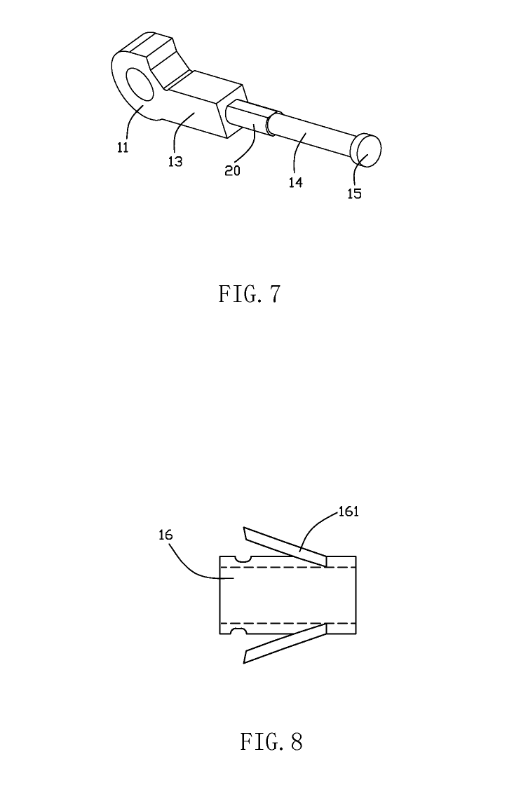

FIG. 7 is a perspective view of the slingshot core 11 of FIG. 6. The installation base 13 can be seen, along with a flanged shaft 20, the central spindle 14, and the stopper 15. The flanged shaft 20 has a square end face (as flattened side) to match with the tube hole of the fixed tube 16 such that the shaft 20 does not rotate relative to the fixed tube 16.

FIG. 8 is a schematic side view of the fixed tube 16 used in the device 100 of FIG. 3.

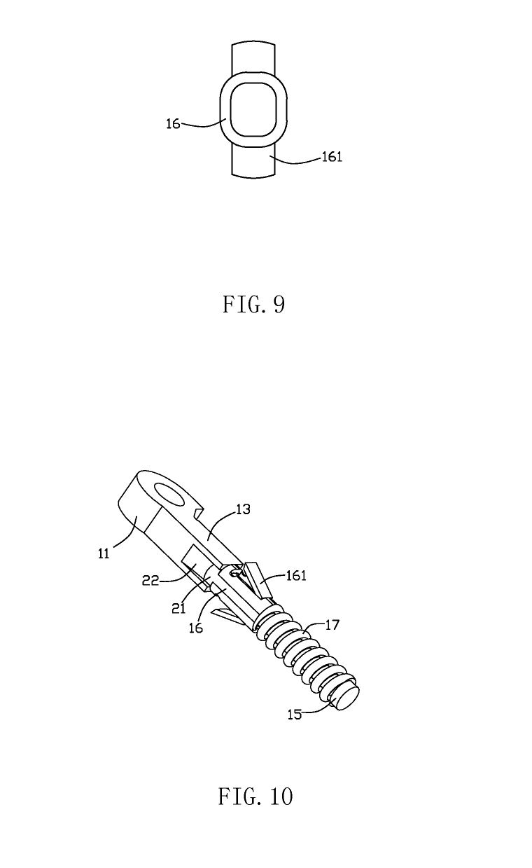

FIG. 9 is a right elevational view of the fixed tube 16 of FIG. 8. This view shows the central opening (unnumbered) and the two barbs 161 extending in opposite directions from the center of the fixed tube 16.

FIG. 10 is a further perspective view of the slingshot core 11 and the components of FIG. 6 which include the fixed tube 16 and the spring 17. The installation base 13 has a fixed groove 22 and a fixed wing 21. Small recesses (unnumbered) are disposed in the fixed tube adjacent the tips of the barbs 161.

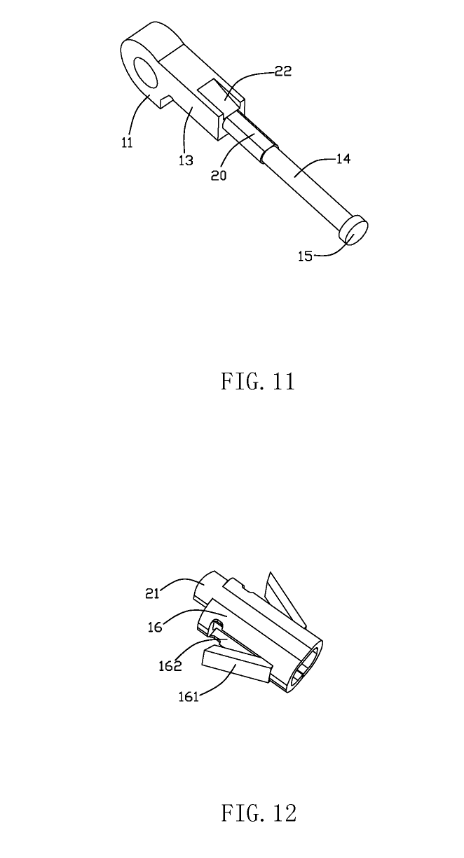

FIG. 11 is a perspective view of the slingshot core 11 of FIG. 10, and shows the fixed groove 22 and the fixed wing 21.

FIG. 12 is a perspective view of the fixed tube 16 of FIG. 10. In this view, it is seen that a return hole 162 is provided, which can be a recess, an opening, or a ledge 162 that serves as a return hole 162 for the movement of the barbs 161.

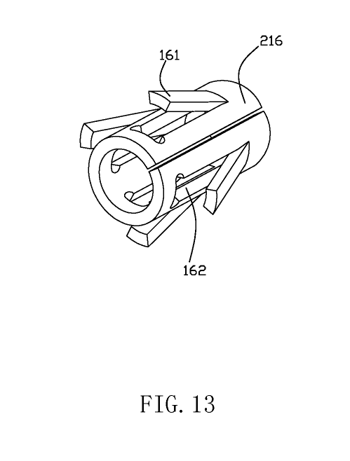

FIG. 13 is a perspective view of an alternative embodiment of a fixed tube 216, corresponding generally to the fixed tube 16 described above. The fixed tube 216 has four barbs 161, and four return holes 162.

In the embodiments 1 and 2 discussed above, both can accept the slingshot core components (described above) with following structure and design. As shown in FIGS. 5, 6, 7, 8, and 9, the barb 161 is cut from the wall of the fixed tube 16. The wall of the fixed tube 16 forms the return holes 162 corresponding to the barbs 161. When the barbs 161 retract, they are received inside the return hole 162. The return holes 162 can be mechanically formed by the step of cutting the barbs 161 from the material forming the fixed tube 16 and bending and stretching the barbs 161. The cross section of the passageway (i.e., the installation hole 12) of the fixed tube 16 is substantially square. The central spindle 14 has been provided with a corresponding flanged shaft 20, which has a square end face to match the entryway of the installation hole 12. The fixed tube 16 is placed on the flanged shaft 20 to prevent the fixed tube 16 and central spindle 14 from moving rotatably relative to each other, around, increasing stability. On the wall of the fixed tube 16, there are two barbs 161, which are located on two opposite walls of the fixed tube 16.

In order to further increase the stability of the slingshot case 10 and the slingshot core 11, the structural design of the slingshot core components can be optimized. As shown in FIGS. 10, 11 and 12, the wall of the fixed tube 16 has been provided with fixed wing 21, which extends along the axis (unnumbered). The installation base 13 has been provided with corresponding fixed grooves 22. The fixed wing 21 can fit inside the fixed groove 22 to prevent fixed tube 16 from moving around, further enhancing stability.

Apart from aforementioned design, FIG. 13 also provides an alternative embodiment. In the alternative embodiment, the hole (unnumbered) of the fixed tube 16 is round and the wall of the tube 16 has been provided with four evenly arranged barbs 161 to facilitate the fixed tube 16 assembly where no adjustment is necessary.

During assembly, the barbs 161 can retract into the return holes 162, which reduces the resistance for the slingshot core 11 to go inside the slingshot case 10 and ensures ease of assembly, saving time and labor; in addition, the fixed tube 16 and the slingshot core 11 are securely connected without any rotation or wobbling; the slingshot core 11 and the slingshot case 10 are reliably connected without looseness, relative rotation, or wobbling, which further improves the opening/closing stability of the earpiece without looseness or wobbling, and thereby improves the quality of the glasses and comfort of wear, and increases its service life.

The production of a kind of elastic hinge 100 that can make the earpiece extend outwards, which is shown as below:
Step 1. Select right sized section bar; stretch and form the section bar with a drawing die to produce the slingshot case 10;
Step 2. Cut sheet material with a laser and produce the slingshot core 11 according to the dimensional requirements;
Step 3. Cut the sheet material with a laser to produce at least one pair of barbs 161; after cutting according to the prescribed description, rolling the sheet into the fixed tube 16 and extend the barbs 161 outwardly;
Step 4. Connect the fixed tube 16 into the central spindle 15 of the slingshot core before it is connected to the spring 17; then, press the end of the central spindle 15 to form the stopper 15;
Step 5. Insert the slingshot core 11 into the slingshot case 10 to complete the assembly.

Above embodiment is by way of example, and shall not restrict the scope of protection for this invention. Under such circumstance, any equivalent transformations made on the basis of the structure, shape, and principle of this invention shall all be included in the scope of this invention.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. An elastic hinge for use in an eyeglass frame that can make an earpiece extend outwards, comprising:
a slingshot case and a slingshot core; one end of said slingshot case having an installation hole; said slingshot core being inserted and fixed inside said slingshot case;
said slingshot core having an installation base and a central spindle; said installation base having a cross-sectional shape which matches a cross-sectional shape of said installation hole;
said central spindle being fixedly connected to said installation base and extending inside said installation hole;
a fixed tube disposed on said central spindle;
a spring disposed on said central spindle;
a stopper disposed on an end of said central spindle; said spring having a first end and a second end and being disposed such that said first end abuts said stopper and said second end abuts said fixed tube;
said fixed tube having at least one flexible barb which extend outwardly;
a ring being disposed inside said installation hole;
in an assembled condition, said at least one flexible barb extending outwardly to abut said ring to secure said fixed tube inside said installation hole;
whereby said slingshot core can be inserted into said installation hole by movement of said at least one flexible barb past said ring by resilient deformation of said at least one flexible barb.

2. An elastic hinge as claimed in claim 1, wherein said ring is a ring-shaped groove formed in said slingshot case, wherein said ring has an inner diameter which is greater than an inner diameter of said installation hole; and wherein said at least one flexible barb acts against a surface of said slingshot case bounding said ring-shaped groove.

3. An elastic hinge as claimed in claim 1, wherein said ring is a ring-shaped convex member having an inner diameter which is smaller than an inner diameter of said installation hole and greater than a diameter of said central spindle.

4. An elastic hinge as claimed in claim 1, wherein said at least one flexible barb are formed from material of said fixed tube; and openings are disposed in a wall of said fixed tube forming return holes for receiving said at least one flexible barb during retraction of said at least one flexible barb.

5. An elastic hinge as claimed in claim 4, wherein said hole of the said fixed tube has a cross sectional shape that is substantially square, and wherein said central spindle has a flanged shaft which has an end face having a substantially square shape which matches said shape of said flanged shaft; and wherein said fixed tube is fixedly connected to said flanged shaft.

6. An elastic hinge as claimed in claim 5, wherein a wall of said fixed tube has two flexible barbs which are located on two opposite tube walls of the fixed tube.

7. An elastic hinge as claimed in claim 4, wherein said hole of said fixed tube is substantially round; and wherein said wall of said fixed tube has four evenly spaced barbs.

8. An elastic hinge as claimed in claim 4, wherein said wall of said fixed tube has a fixed wing that extends along an axial direction of said fixed tube; and a corresponding mounting groove on said installation base; wherein said fixed wing is adapted to be connected inside of said fixed groove.

9. An elastic hinge as claimed in claim 1, wherein said installation base and an end of said installation hole end having matching square cross sectional shapes, so that said installation base can be received within said installation hole.

10. A production method for making an elastic hinge described in claim 1 that can cause an eyeglass frame earpiece extend outwards, comprising the steps of:
Step 1: selecting a suitably sized section bar; stretching and forming the section bar with a drawing die to produce a slingshot case;
Step 2: cutting a sheet material with a laser to produce a flat sheet;
Step 3: cutting the flat sheet with a laser to produce at least one pair of barbs;
and after cutting then rolling the flat sheet into a fixed tube; and then extending the barbs outwardly;
Step 4: providing a slingshot core having a central spindle, and then connecting the fixed tube onto the central spindle of the slingshot core; providing a spring and then connecting the spring onto the central spindle; and pressing a free end of the central spindle to form a stopper; and
Step 5: inserting the slingshot core into the slingshot case to complete the assembly.
